(19) United States
(12) Patent Application Publication
(10) Pub. No.: US 2023/0360045 A1
(43) Pub. Date: Nov. 9, 2023

(54) SYSTEM AND METHOD OF BLOCKCHAIN TRANSACTIONS

(71) Applicants: IVAN ASSENOV, WYOMING, MI (US); ADAM KLING, SILER CITY, NC (US); DAVID CASE, GRAND RAPIDS, MI (US); ABEL DANTAS, VIANA DO CASTELO (PT)

(72) Inventors: IVAN ASSENOV, WYOMING, MI (US); ADAM KLING, SILER CITY, NC (US); DAVID CASE, GRAND RAPIDS, MI (US); ABEL DANTAS, VIANA DO CASTELO (PT)

(21) Appl. No.: 18/124,823

(22) Filed: Mar. 22, 2023

Related U.S. Application Data
(60) Provisional application No. 63/326,577, filed on Apr. 1, 2022.

(51) Int. Cl. G06Q 20/38; H04L 9/00; A63F 13/69; A63F 13/537

(52) U.S. Cl. CPC G06Q 20/389; H04L 9/50; G06Q 20/3825; A63F 13/69; A63F 13/537

(57) ABSTRACT

Disclosed is a distributed blockchain system and method for blockchain transactions for users for a virtual environment. The virtual environment has at least one or more of virtual space, time, virtual objects, and avatars, inclusive of a game environment, wherein users execute moves, the moves allowing users to earn from outcomes of moves at least one or more of tokens, skills, and tools, the tools being an element of the virtual objects and the skills being an element of the avatars. A validator is designed to validate moves and move outcomes. A transaction aggregator is designed to accumulate related layer-one transactions in the blockchain. The accumulated related transactions are viewable on one or more user interfaces wherein at least one or more of moves, outcomes of moves, associated non-interchangeable units of data, the tokens, the tools, the virtual transaction space, the time, the virtual transaction objects, and the avatars.

### CLAIM OF PRIORITY

This application claims priority to and the benefit of U.S. Provisional application with Ser. No. 63/326,577, filed on Apr. 1, 2022, with the same title, the contents of which are hereby incorporated by reference in its entirety.

### FIELD OF THE INVENTION

The inventive concept relates generally to a system and method of blockchain transactions in video game and other transaction environments.

### BACKGROUND

The idea of a centralized virtual world parallel to the physical world has inspired the imaginations of people worldwide. Enterprises, exemplified by META, have drawn people to spend time in virtual spaces and to take ownership in digital properties. Blockchain and associate non-fungible tokens (NFTs) and cryptocurrencies have been utilized to physicalized digital items, meaning that blockchain ensures a digital item can be a singular item for ownership. For illustration, whereas a virtual space could be infinitely large, limited only by the computer processing power able to handle associated data, blockchain can be used to create limits. Mining in the blockchain to create new virtual space could be capped, therefore creating scarcity and associated opportunities to raise the value of given virtual space.

People using virtual space seek something to do. One thing common to do in a virtual space is to participate in games. Games can include competitive games where value may be stakes beyond the pride of winning to include earning assets such as cryptocurrency, virtual items, and items such as cash and rewards outside the virtual world. Such games, however, invite the possibility of cheating, and the possibility of cheating can be substantially reduced or limited via blockchain by recording activities and transactions. But such recording is limited by blockchain scalability. Therefore, there is a need in the market for an improved way to utilize blockchain transactions in a virtual world.

### SUMMARY OF THE INVENTION

Disclosed is a distributed blockchain system and method for blockchain transactions for users for a game environment and a transaction environment. The system has a plurality of nodes, wherein the plurality of nodes communicates over a network assembly. A network interface assembly has one or more network devices. At least one control circuit assembly is designed to receive and transmit information via the network assembly.

A game environment, in one embodiment, has at least one or more of virtual game space, game time, virtual game objects, and game avatars disposed within the at least one computer-readable storage memory assembly wherein users execute moves, the moves allowing users to earn from outcomes of moves at least one or more of tokens, skills, and tools, the tools being an element of the virtual game objects and the skills being an element of the game avatars.

A transaction environment, in another embodiment, has at least one or more of virtual transaction space, time, virtual transaction objects, and avatars disposed within the at least one computer-readable storage memory assembly wherein users execute moves, the moves allowing users to earn from outcomes of moves at least one or more of tokens, skills, and tools, the tools being an element of the virtual objects and the skills being an element of the avatars.

A validator is designed to validate moves and move outcomes. A transaction aggregator is designed to accumulate related transactions in the blockchain. The distributed blockchain system for blockchain transactions for users further includes at least one computer-readable storage memory assembly, wherein the computer-readable storage memory assembly comprises a volatile memory storing a set of one or more computer-readable interactions, which when executed by the control circuit assembly cause the plurality of nodes to update the blockchain stored in a memory assembly based on communication with other nodes over the network assembly, which is then designed to be updated with at least one or more of the outcomes and increments of the outcomes.

The accumulated related transactions are viewable on one or more user interfaces wherein at least one or more of moves, outcomes of moves, associated non-interchangeable units of data, the tokens, the tools, the virtual transaction space, the time, the virtual transaction objects, and the avatars, subsets of which, when present, may be the virtual game space, the game time, the virtual game objects, and the game avatars, are all viewable from the accumulated related transactions within the transaction environment and any associated game environment subset by way of at least one or more encrypted private keys. The game environment and the transaction environment may collectively be termed a virtual environment.

One embodiment of the distributed blockchain system for blockchain transactions further includes secured digital content disposed on the at least one control circuit assembly. The retrievable digital content may include at least one evolving avatar wherein the avatar is evolvable into at least one or more of appearance and capabilities at least one or more of automatically and on demand upon reaching a threshold, the threshold including one or more from a group of spatial considerations, temporal considerations, material considerations, and considerations associated with handling risks.

One embodiment of the distributed blockchain system for blockchain transactions may include avatars created as one or more sets of avatars (A1, A2, A3 . . . An) that are controlled inside of the environment wherein the user can access one avatar of the set of avatars at a time, the avatar evolvable wherein an evolved avatar represents an older version of a corresponding and previous avatar of the given set off avatars.

The distributed blockchain transactions in one represented embodiment includes the mining enterprise mining at least one block, a plurality of transactions held in each block therein up to between, inclusively, 2.8 gigabytes and 5.0 gigabytes, the ancestry pool set to 8,000 to 15,000 transactions per block related to each other.

One embodiment of the distributed blockchain transactions includes explicit transactions wherein users execute moves in the virtual environment, the moves allowing users to earn from outcomes of moves at least one or more of tokens, skills, and tools, the explicit transactions recorded on the plurality of nodes.

In one embodiment of the distributed blockchain transactions, the explicit transaction means is Bitcoin SV. Other embodiments may use other transaction means. Embodiments may fork code or blocks of code to create further chains.

In one embodiment of the distributed blockchain transactions, users dispense at least one token portion to perform actions within the virtual environment and may receive at least one token portion as a prize or reward.

Further disclosed is a distributed blockchain method for blockchain transactions for users in a virtual environment, one embodiment being a game environment, the method involving move and outcomes of moves creating a transaction event on which is assigned new blockchain code.

Embodiments of the inventive concept use proof of work consensus models involving solving complex cryptographic mathematical equations via computer processors and adding new blocks of transactions to a blockchain. Embodiments of the inventive concept are designed to improve scalability in proof of work consensus model.

The inventive concept now will be described more fully hereinafter with reference to the accompanying drawings, which are intended to be read in conjunction with both this summary, the detailed description and any preferred and/or particular embodiments specifically discussed or otherwise disclosed. Inventive concepts may, however, be embodied in many different forms and should not be construed as limited to the embodiments set forth herein; rather, these embodiments are provided by way of illustration only and so that this disclosure will be thorough, complete, and will fully convey the full scope of the inventive concepts to those skilled in the art.

### BRIEF DESCRIPTION OF THE DRAWINGS

FIG. 1 illustrates a game environment.

FIG. 2 illustrates a transaction aggregator and validator.

FIG. 3A illustrates a node and network assembly for the computer-implemented system and method for a game environment and transaction environment.

FIG. 3B illustrates a computer processor for the computer-implemented system and method for a game environment and transaction environment.

FIG. 3C illustrates a database for storing information and data.

FIG. 4 illustrates a transaction environment.

FIG. 5 illustrates a blockchain system for the computer-implemented system and method for merging digital content.

FIG. 6 illustrates an evolving avatar for a game environment.

FIG. 7 illustrates Bitcoin SV in the game environment and transaction environment.

FIGS. 8A-8C illustrate a representative method for blockchain transactions for users in a game environment.

FIG. 9 illustrates an evolving avatar for a transaction environment.

FIG. 10 illustrates a representative method for blockchain transactions for users in a virtual environment.

FIG. 11 illustrates a representative table of transaction results.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The inventive concept utilizes a peer-to-peer authentication system for recording actions within at least one or more of a game environment and transaction environment and for tracking valuable digitized items such as, but not limited to, for example: 1) digital cash; 2) digital tokens; 3) private financial data; 4) chain of title to one or more rights; 5) real property; 6) digital wallet; 7) digital representation of rights including, such as, for example, a license to intellectual property; 8) digital representation of a contractual relationship; 9) medical records; 10) security clearance rights; 11) background check information; 12) passwords; 13) access control information for physical or virtual space; 14) digital artwork; 15) digital images; 16) digital video or audio; 17) digital objects such as digital tools; 18) intellectual property; and 19) combinations, variations, and permutations of one or more of the foregoing that allows online interactions directly between two or more parties without going through one or more trusted intermediaries. A peer-to-peer network timestamps actions include, but are not limited to, for example: 1) record transfer, 2) record access, 3) record change, 4) record copying, 5) record merging, or 6) other activities through which the digital content is used for 1) its content as an item for trade, 2) its content as a record to be verifiably maintained or changed, or 3) as an item for remuneration, hashing them into an ongoing chain of hash-based proof-of-work code to form a record that cannot be changed without redoing the proof-of-work. The longest chain distributed on the peer-to-peer network proves that the data must have existed at the time to get into the hash, thereby proving the sequence of events witnessed, thereby further proving that the integrity of the digitized record has been maintained. A new block is added, creating a new chain that now becomes the longest block, and the digitized content is recorded and may be moved to a receiving party.

The disclosed system and method allow digitized items and records to be used as intended based on cryptographic proof instead of trust, allowing any two or more willing parties to utilize the record as intended without the need to trust each other and without the need for a trusted third party. The purpose includes, but is not limited to, ensuring that a digital record is 1) a unique and unaltered original; 2) was not altered after a given timestamp; 3) that alterations made can be followed to a traceable point of origin; 4) that only people with authorized keys can access the record; 5) that the record itself cannot be duplicated; 6) that where duplication is allowed, the integrity of the copied record is maintained along with the original; 7) that the record creator was authorized to create the record or take the actions associated with creating the record; or 8) that the user was authorized to transfer, alter, or otherwise act on the record.

One of ordinary skill in the art would recognize that a cryptographic system of one or more encrypted private keys, also known as hashtag keys, uses pairs of keys: 1) public keys, which may be disseminated widely, and 2) private keys, which are known only to the owner. Key generation depends on cryptographic algorithms based on mathematical problems to produce one-way functions. Effective security only requires keeping the private key private. The public key can be openly distributed without compromising security.

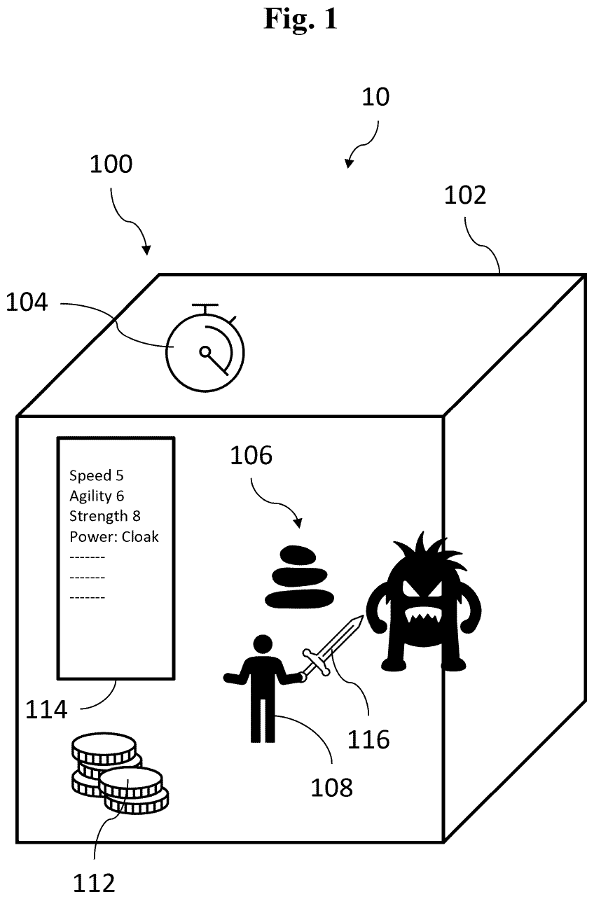

FIG. 1 illustrates an embodiment of the disclosed distributed blockchain system 10 for blockchain transactions for users for a game environment. A game environment 100 is provided which includes a virtual surrounding and conditions which collaborates game rules, objectives, subject, and theoretical aspects together as a whole to provide a flow of interactive activity. The game environment 100 may be a primarily two dimensional or three-dimensional space and may also include dimensions of time wherein the user may travel back and forth in game time even as blockchain is recorded in linear time as experienced by people outside the game environment 100.

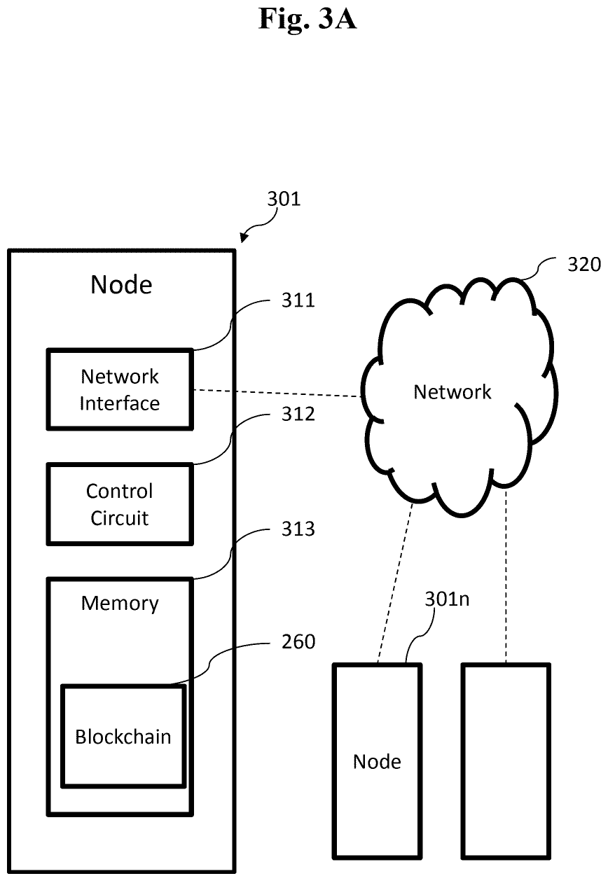

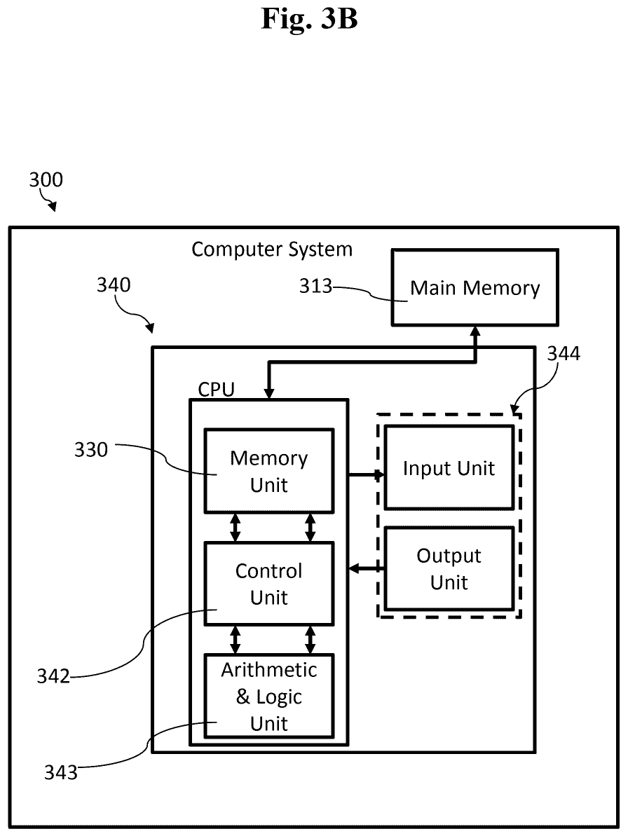

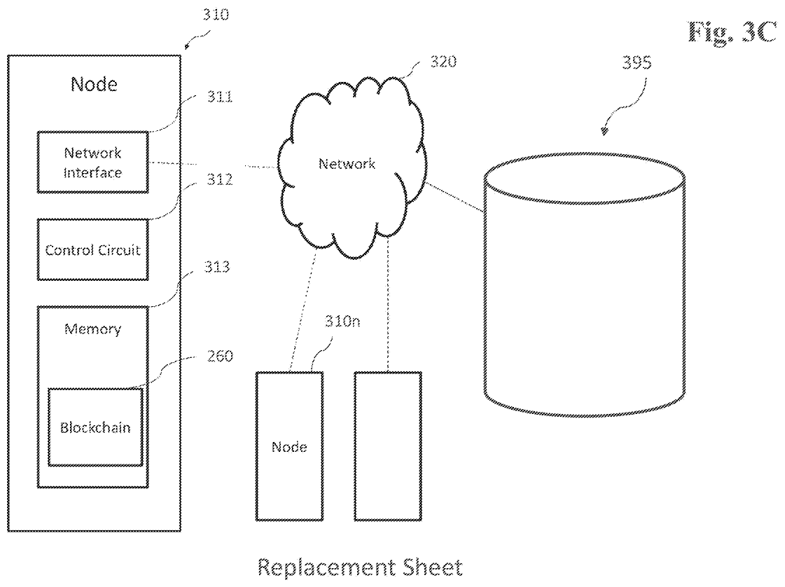

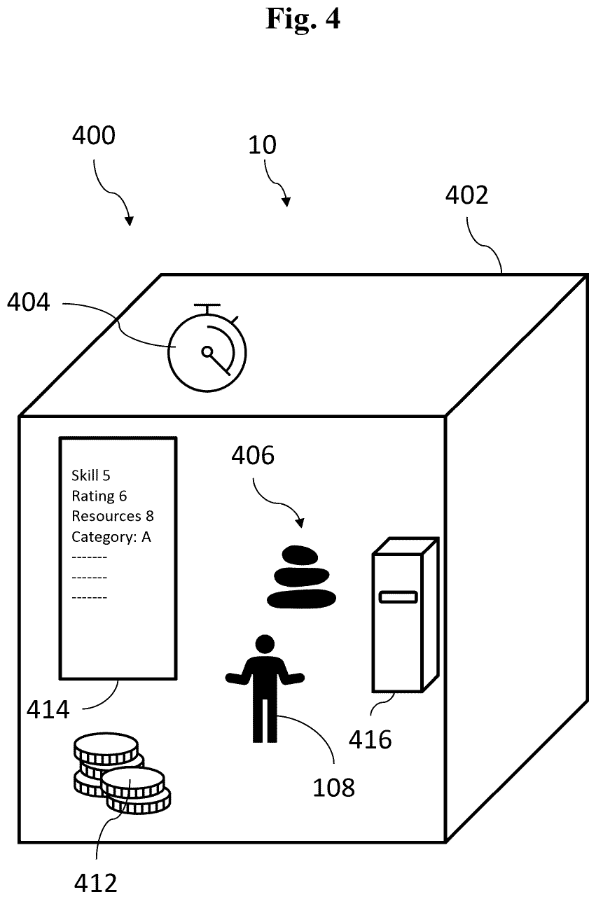

As illustrated in FIGS. 3A-3C, the disclosed distributed blockchain system 10 has the plurality of nodes 301n, wherein the plurality of nodes 301n communicates over a network assembly 320. A network interface assembly 311 has one or more network devices. At least one control circuit assembly 312 of the computer system 300 is designed to receive and transmit information via the network assembly 320. the game environment 100 has at least one or more of virtual game space 102, game time 104, virtual game objects 106, and game avatars 108 disposed within the at least one computer-readable storage memory assembly 330 wherein users execute moves, the moves allowing users to earn from outcomes of moves at least one or more of tokens 112, skills 114, and tools 116, the tools 116 being an element of the virtual game objects 106 and the skills 114 being an element of the game avatars 108. A game avatar is an image that represents at least one or more of users or characters controlled by users presented as images that represents users within the game environment 100 and may include associated environments such as chat rooms or virtual environments outside the game environment 100 such as a virtual locker room, virtual stadium, or virtual holding area, the avatars being movable and controllable by the users. Users are people but also may be computer users such as when a player competes against a computer instead of another person or when a person may receive computer assistance controlling the avatar 108.

Whereas the representative embodiment illustrated by FIGS. 3A-3C is a game environment 100, another embodiment supported by FIGS. 3A-3C is a transaction environment 400, as illustrated by FIG. 4. The underlying computer system 300 is the same, and the game environment 100 may be within the transaction environment 400.

FIG. 1 further illustrates that in one embodiment of the distributed blockchain transactions for users in a game environment, users dispense at least one token 112 portion to perform actions within the game environment 100 and may receive at least one token 112 portion as a prize or reward. A token 112 represents a set of rules encoded in a smart contract. Each token 112 belongs to a blockchain address and is substantially a digital asset stored on the blockchain. Tokens 112 may also be termed cryptocurrencies such as Bitcoin.

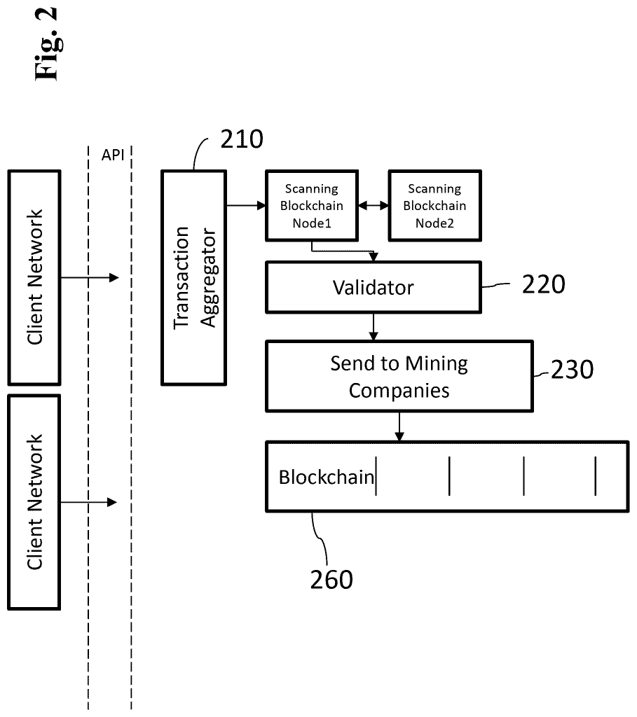

FIG. 2 illustrates a validator 220 designed to validate moves and move outcomes within the game environment 100 and, as illustrated in FIG. 4, a transaction environment 400. Validators on a Proof-of-Work, PoW, layer-one blockchain 260, which may be considered miners, try to validate a block by finding an answer to a complex computational puzzle. This process is competitive, and the first validator node that successfully solves the puzzle is rewarded with some amount of cryptocurrency for their effort. A transaction aggregator 210 is designed to accumulate related transactions in the blockchain 260. The transaction aggregator 210 brings together trades across decentralized finance platforms.

Layer one blockchain includes base networks such as, but not limited to, BNB Smart Chain (BNB), Ethereum (ETH), Bitcoin (BTC), and Solana and their associated infrastructures. Layer one blockchains are designed to be validated and transactions finalized without needing another network. The inventive concept discloses a scalable layer one blockchain 260. Layer one blockchain is distinct from layer two block-chain, the latter which operates on top of an underlying blockchain protocol—this being the noted another network—as its means to improve its scalability and efficiency.

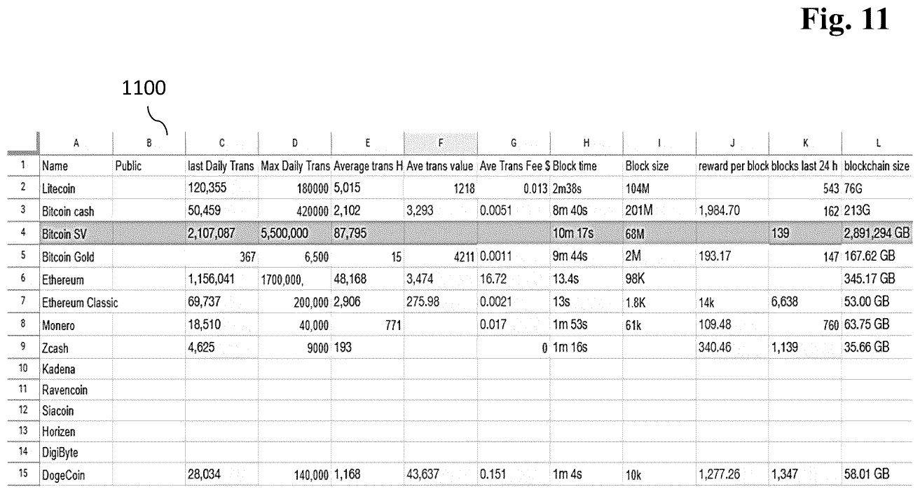

Disclosed layer-one blockchain 260 scaling solutions augment the base layer of the blockchain protocol itself to improve scalability, for example by at least one or more of increasing the amount of data contained in each block, accelerating the rate at which blocks are confirmed, and processing volumes of data as a unit, each to increase network throughput over throughput possible without the layer-one blockchain 260 scaling solutions. The representative embodiment employs layer-one blockchain 260 for scalability. FIG. 11 illustrates one daily dataset for scalability as an example comparison 1100.

FIG. 2 further illustrates that one embodiment of the distributed blockchain transactions for users in a game environment, in one represented embodiment, includes the mining enterprise 230 mining at least one block, a plurality of transactions held in each block therein up to between 2.8 gigabytes and 5.0 gigabytes, the ancestry pool set to 8,000 to 15,000 transactions per block related to each other.

FIGS. 3A-3C further illustrate that at least one computer-readable storage memory assembly 340—wherein the computer-readable storage memory assembly 340 comprises a volatile memory storing a set of one or more computer-readable interactions, which when executed by the control circuit assembly 312—cause the plurality of nodes 301n to update the blockchain stored in the memory assembly 330 based on communication with other nodes 301n over the network assembly 320, the blockchain 260 is designed to be updated with at least one or more of the outcomes and increments of the outcomes. The accumulated related transactions are viewable on one or more user interfaces 311 wherein at least one or more of moves, outcomes of moves, associated non-interchangeable units of data, the tokens 112, the tools 116, the virtual game space 102, the game time 104, the virtual game objects 106, and the game avatars 108 are viewable from the accumulated related transactions within the game environment 100 by way of at least one or more encrypted private keys.

FIG. 3A, in particular, illustrates the network interface assembly 311 may have one or more network devices configured to allow the control circuit assembly 312 to receive and transmit information via the wireless network assembly 320. In some embodiments, the network interface assembly 311 may have one or more of a network modem, a router, data port, and transceiver assembly. The network assembly 320 may have a communication network assembly 320 configured to allow the one or more nodes 301n to exchange data. In some embodiments, the network assembly 320 may have one or more of the Internet, a local area network, a private network, a virtual private network, a home network, a wired network, and the wireless network assembly 320. In some embodiments, the system does not include a central server assembly and/or a trusted third-party system. Each node 301n in the system may enter and leave the network assembly 320 at any time.

With reference to FIG. 3B, a central processing unit (CPU) 340, also called a central processor or main processor, is the electronic circuitry within the computer 300 that executes instructions that make up a computer program. The CPU 340 performs basic arithmetic, logic, controlling, and input/output (I/O) operations specified by the instructions in the program. An arithmetic & logic unit (ALU) 346 is a combination digital electronic circuit that performs arithmetic and bitwise operations in integer binary numbers. Traditionally, the term CPU 340 refers to a processor, more specifically to its processing unit and control unit (CU) 342, distinguishing these core elements of a computer from external components such as main memory 313 and input output (I/O) circuitry 344. A CPU 340 may also contain memory 330. Memory 330 refers to a component that is used to store information for immediate use in a computer.

FIG. 3C, with reference to FIG. 3B, herein illustrates a one or more databases 395 that may store information/data, as described herein inclusive of aggregated transaction data from the transaction aggregator 210.

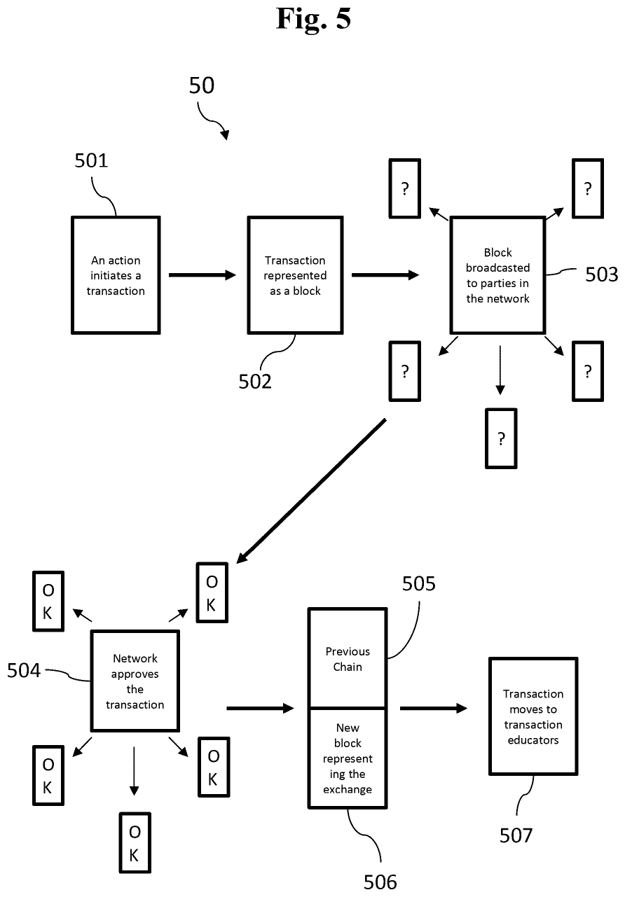

Now referring to FIG. 5, a process diagram 50, a blockchain update according to some implementations is shown. In step 501 of the process, an action initiates a transaction that would be validated within the validator 220 and disposed to the transaction aggregator 210. In some embodiments, the user may prove that the action has happened with a private key that may be verified with a public key in the previous transaction. In step 502, the transaction is initiated in step 501 and is represented as a block. In some embodiments, the transaction may be compared with transaction records in the longest chain in the distributed system to verify the action. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-time, or proof-of-space, may be used in the system. In some embodiments, a block may represent one or more transactions that are broadcasted to the nodes 301n. In step 503, the block is broadcasted to parties in the network. In step 504, nodes in the network approve the exchange by examining the block that contains the aggregated transactions. In some embodiments, the nodes may check the solution provided as proof-of-work to approve the block. In some embodiments, the nodes may check the transaction against the transaction record in the longest blockchain in the system to verify that the transaction is valid reflecting a given action. In some embodiments, a block may be approved with consensus of the nodes 301n in the network 310.

After a block is approved, the new block 506 representing the exchange is added to the existing chain 505 comprising blocks that chronologically precede the new block 506. The new block 506 may contain the transaction or transactions and a hash of one or more blocks in the existing chain 505. In some embodiments, each node may then update their copy of the blockchain with the new block and continue to work on extending the chain with additional transactions. In step 507, when the chain is updated with the new block, the block is aggregated within the transaction aggregator 210.

FIGS. 1 and 5 further illustrate that one embodiment of the distributed blockchain transactions for users in a game environment includes explicit transactions wherein users execute moves in the game environment 100, the moves allowing users to earn from outcomes of moves at least one or more of tokens 112, skills 114, and tools 116, the explicit transactions recorded on the plurality of nodes 301n.

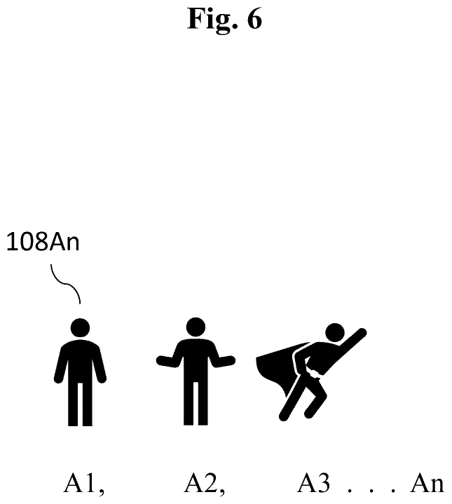

FIG. 6 illustrates one embodiment of the distributed blockchain system for blockchain transactions for users in a game environment that further includes secured digital content disposed on the at least one control circuit assembly 312. The retrievable digital content may include at least one evolving avatar 108An for a game environment wherein the avatar 108 is evolvable into at least one or more of appearance and capabilities at least one or more of automatically and on demand upon reaching a threshold, the threshold including one or more from a group of spatial considerations, temporal considerations, material considerations, and considerations associated with handling risks, risks including game challenges such as to reach or fail to reach goals.

FIG. 6 further illustrates that one embodiment of the distributed blockchain system for blockchain transactions for users in a game environment may include avatars 108 created as one or more sets of avatars (A1, A2, A3 . . . An) that are controlled inside of the game wherein the user can access one avatar 108 of the set of avatars 108 at a time, the avatar 108 evolvable wherein an evolved avatar 108An represents an older version of a corresponding and previous avatar 108 of the given set off avatars 108.

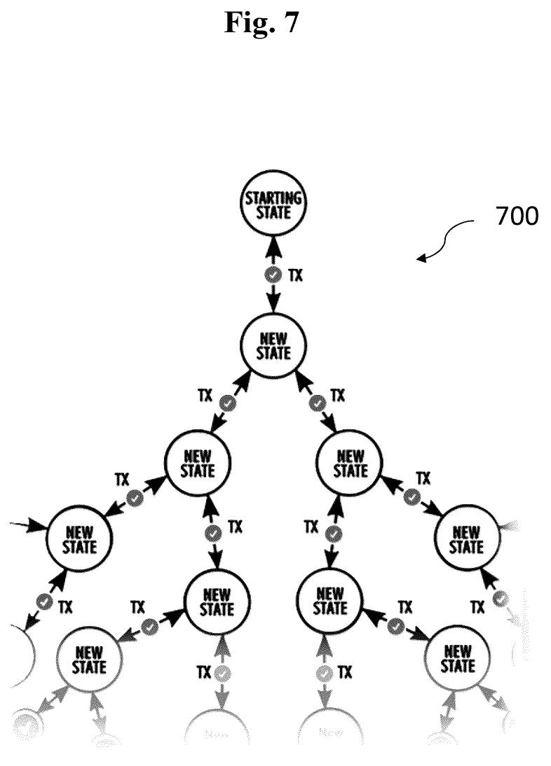

FIG. 7 illustrates one embodiment of the distributed blockchain transactions for users in a game environment the explicit transaction means is Bitcoin SV 700. Bitcoin SV 700 is a fork of Bitcoin Cash (BCH) which was further a fork of Bitcoin designed to improve scalability. Other embodiments may use other transaction means that share characteristics of Bitcoin SV 700 and may include variants of Bitcoin, alternative transaction means, and may incorporate or address code forks. In blockchain, a fork is defined variously as a blockchain diverging into two potential paths forward where the fork may be the result of competing miners, or the fork may be a deliberate modification and may include code used for and applicable to the disclosed gaming and transaction environments. Absent scalability, blocks are otherwise capped by a one-megabyte limit in block size for Bitcoin and thirty-two megabytes for Bitcoin Cash. Bitcoin SV 700 attempts to restore the original Bitcoin protocol as defined by Bitcoin and bitcoin cash.

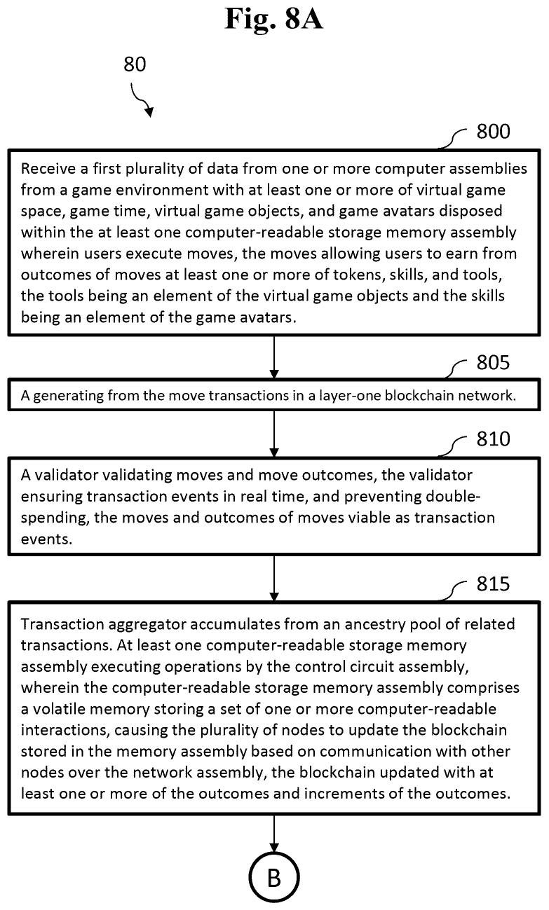

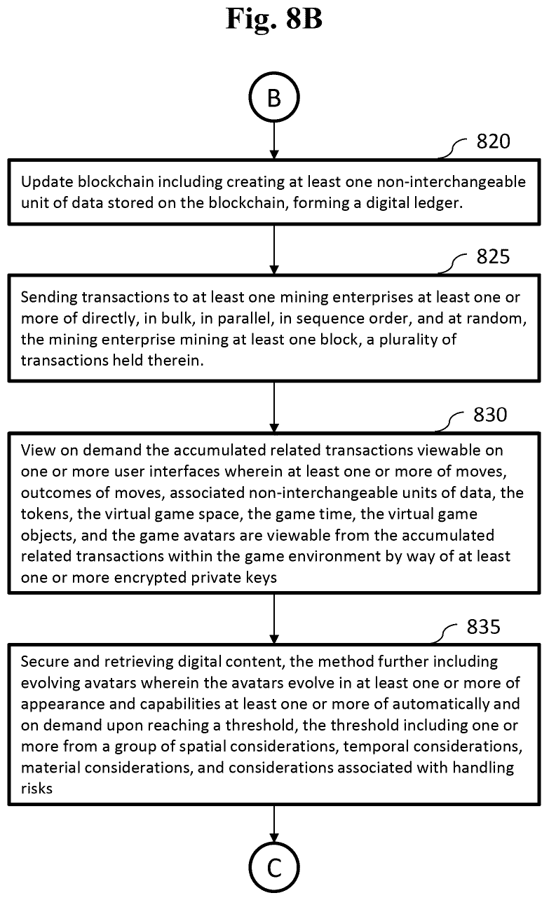

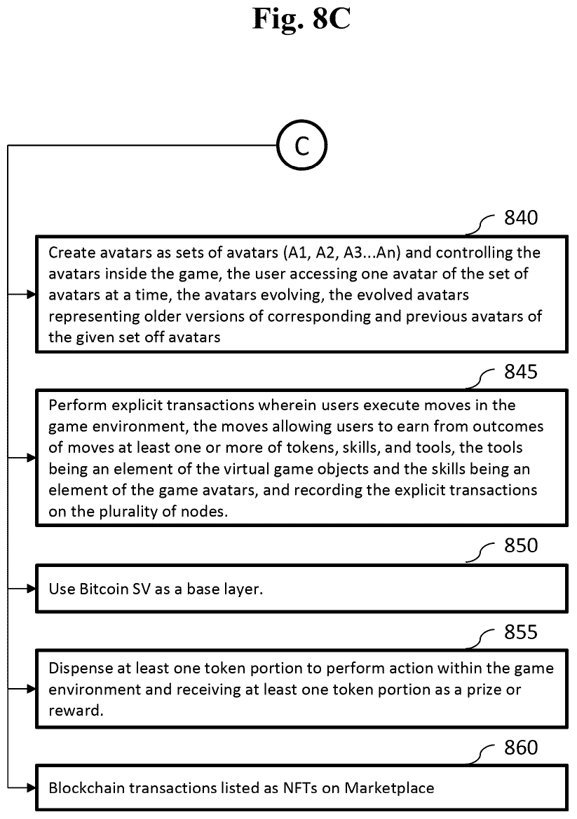

Further disclosed is a distributed blockchain method 80 for blockchain transactions for users, in one representative embodiment, in a game environment, as illustrated in FIGS. 8A-8C, the method including the step of 800 receiving a first plurality of data from one or more computer assemblies from the game environment 100 with at least one or more of virtual game space 102, game time 104, virtual game objects 106, and game avatars 108 disposed within the at least one computer-readable storage memory assembly 330 wherein users execute moves, the moves allowing users to earn from outcomes of moves at least one or more of the tokens 112, skills 114, and tools 116, the tools 116 being elements of the virtual game objects 106 and the skills 114 being elements of the game avatars 108.

FIGS. 8A-8C illustrates that the method further includes the step of 805, generating from the move transactions in a layer-one blockchain network. The method further includes the step of 810, the validator 220 validating moves and move outcomes, the validator 220 ensuring transaction events in real time, and preventing double-spending, the moves and outcomes of moves viable as transaction events. The method further includes the step of 815 the transaction aggregator 210 accumulating from the ancestry pool of related transactions. At least one computer-readable storage memory assembly 330 executing operations by the control circuit assembly 312, wherein the computer-readable storage memory assembly 330 comprises the volatile memory storing the set of one or more computer-readable interactions, causing the plurality of nodes 301n to update the blockchain 260 stored in the memory assembly 330 based on communication with other nodes 301n over the network assembly 320, the blockchain 260 updated with at least one or more of the outcomes and increments of the outcomes.

FIGS. 8A-8C illustrates that the method further includes the step of 820, the updated blockchain 260 including creating at least one non-interchangeable unit of data stored on the blockchain 260, forming a digital ledger. The method further includes the step of 825, sending transactions to at least one mining enterprises at least one or more of directly, in bulk, in parallel, in sequence order, and at random, the mining enterprise mining at least one block, a plurality of transactions held therein. The method further includes the step of 830, viewing on demand the accumulated related transactions viewable on one or more user interfaces 311 wherein at least one or more of moves, outcomes of moves, associated non-interchangeable units of data, the tokens 112, the virtual game space 102, the game time 104, the virtual game objects 106, and the game avatars 108 are viewable from the accumulated related transactions within the game environment 100 by way of at least one or more encrypted private keys.

FIG. 8B illustrates that the distributed blockchain method for blockchain transactions for users in a game environment further includes the step of 835, securing and retrieving digital content, the method further including evolving avatars 108An wherein the avatars 108 evolve in at least one or more of appearance and capabilities at least one or more of automatically and on demand upon reaching a threshold, the threshold including one or more from a group of spatial considerations, temporal considerations, material considerations, and considerations associated with handling risks.

FIG. 8C illustrates that the distributed blockchain method for blockchain transactions for users in a game environment may further include the step of 840, creating avatars as sets of avatars 108 (A1, A2, A3 . . . An) and controlling the avatars 108 inside the game, the user accessing one avatar 108 of the set of avatars 108 at a time, the avatars 108 evolving, the evolved avatars 108An representing older versions of corresponding and previous avatars 108 of the given set off avatars 108 (A1, A2, A3 . . . An).

FIG. 8C illustrates that the distributed blockchain method for blockchain transactions for users in a game environment may further include the step of 845, performing explicit transactions wherein users execute moves in the game environment 100, the moves allowing users to earn from outcomes of moves at least one or more of tokens 112, skills 114, and tools 116, the tools 116 being an element of the virtual game objects 106 and the skills 114 being an element of the game avatars 108, and recording the explicit transactions on the plurality of nodes 301n, blockchain transactions further distributed in step 860 as NFTs in the marketplace.

FIG. 8C illustrates that the distributed blockchain method for blockchain transactions for users in a game environment may further include the step of 850, using Bitcoin SV 700 as a base layer.

The distributed blockchain method for blockchain transactions for users in a game environment further including the step of 855, dispensing at least one token 112 portion to perform action within the game environment 100 and receiving at least one token 112 portion as a prize or reward.

The distributed blockchain method for blockchain transactions for user in a game environment may be applied to a general transaction environment 400. The game environment 100 is a representative embodiment.

Further disclosed is a distributed blockchain system for blockchain transactions for users for the transaction environment 400. A distributed blockchain system for blockchain transactions for users has the plurality of nodes 301n, wherein the plurality of nodes 301n communicates over the network assembly 320. The network interface assembly 311 has the one or more network devices. At least one control circuit assembly 312 is designed to receive and transmit information via the network assembly 320.

FIG. 4 illustrates that the transaction environment 400 has the at least one or more of virtual space, time, virtual objects, and avatars is disposed within the at least one computer-readable storage memory assembly 330 wherein users execute actions, the actions allowing users to earn from outcomes of actions, to include the action of doing nothing, at least one or more of tokens 412, skills 414, and tools 416, the tools 416 being an element of the virtual objects 406 and the skills 414 being an element of the avatars 408. The validator 220, in the embodiment associated with FIG. 4, is designed to validate moves and move outcomes. The transaction aggregator 210 is designed to accumulate related transactions in the blockchain 260. At least one computer-readable storage memory assembly 330, wherein the computer-readable storage memory assembly 330 comprises the volatile memory storing the set of one or more computer-readable interactions, which when executed by the control circuit assembly 312 cause the plurality of nodes 301n to update the blockchain 260 stored in the memory assembly 330 is based on communication with other nodes 301n over the network assembly 320, the blockchain 260 designed to be updated with at least one or more of the outcomes and increments of the outcomes. The accumulated related transactions are viewable on one or more user interfaces 311 wherein at least one or more of moves, outcomes of moves, associated non-interchangeable units of data, the tokens 412, the tools 416, virtual space 402, time 404, the virtual objects 406, and the avatars 408 are viewable from the accumulated related transactions within the transaction environment 400 by way of at least one or more encrypted private keys.

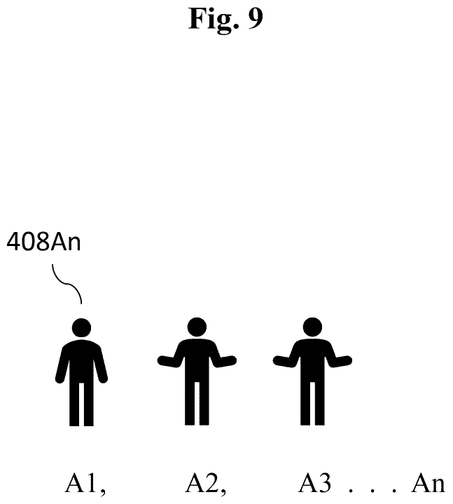

One embodiment of the distributed blockchain transactions for users in a transaction environment of claim includes secured digital content disposed on the at least one control circuit assembly 312, the retrievable digital content including at least one, as illustrated in FIG. 9, evolving avatar 408An wherein the avatar 408 is evolvable into at least one or more of appearance and capabilities for a transaction environment at least one or more of automatically and on demand upon reaching a threshold, the threshold including one or more from the group of spatial considerations, temporal considerations, material considerations, and considerations associated with handling risks.

In one embodiment of the distributed blockchain transactions for users in a transaction environment includes avatars 408 created as one or more sets of avatars 408 (A1, A2, A3 . . . An) that are controlled inside of the transaction environment 400 wherein the user can access one avatar 408 of the set of avatars 408 at a time, the avatar 408 evolvable wherein the evolved avatar 408An represents an older version of a corresponding and previous avatar 408 of the given set off avatars 408 (A1, A2, A3 . . . An).

One embodiment of the distributed blockchain transactions for users in a transaction environment includes the user dispensing at least one token 412 portion to perform action within the transaction environment 400 and may receive at least one token 412 portion as a prize or reward.

One embodiment of the distributed blockchain transactions for users in a transaction environment includes the mining enterprise 230 mining at least one block, a plurality of transactions held in each block therein up to between 2.8 gigabytes and 5.0 gigabytes, the ancestry pool set to 8,000 to 15,000 transactions per block related to each other.

One embodiment of the distributed blockchain transactions for users in a transaction environment further includes explicit transactions wherein users execute moves in the transaction environment 400, the moves allowing users to earn from outcomes of moves at least one or more of the tokens 412, skills 414, and tools 416, the tools 416 being an element of the virtual transaction objects 406 and the skills 414 being an element of the avatars 408, the explicit transactions recorded on the plurality of nodes 301n.

In one embodiment of the distributed blockchain transactions for users in a transaction environment, the explicit transaction means is Bitcoin SV 700.

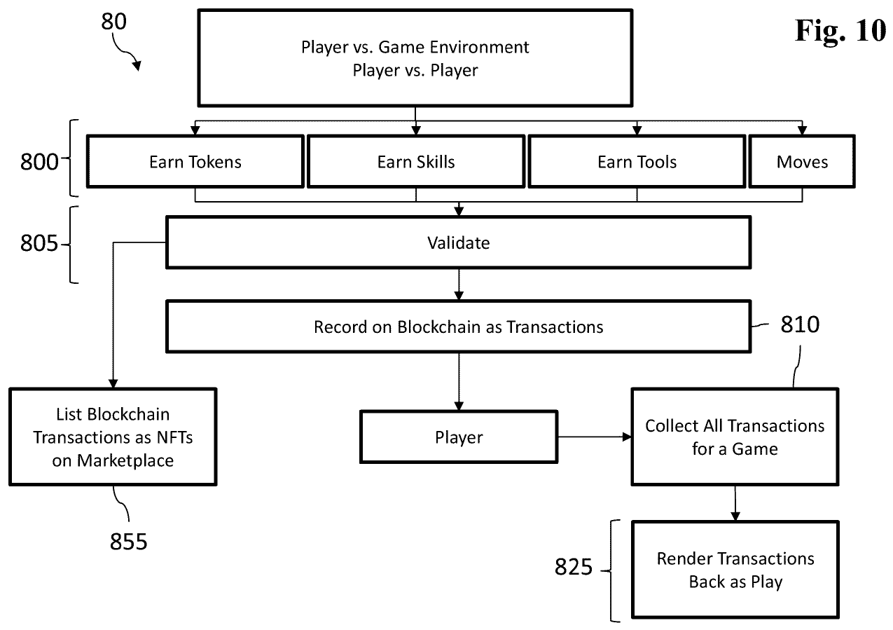

FIG. 10 provides another illustration of the representative method for blockchain transactions for users in a virtual environment. Illustrated is the step including validation 805, the step including transaction aggregation 810, and the step including transaction playback 825. Illustrated is the listing of blockchain transactions as NFTs on the marketplace 855.

The following patents and publications are incorporated by reference in their entireties: patent U.S. Ser. No. 10/833,864B2, U.S. Ser. No. 10/972,279B2, U.S. Ser. No. 11/074,661B2, U.S. Ser. No. 11/196,543B2, US20190282906A1, US20200293633A1, US20210106920A1, and US20210252407A1.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

1. A distributed blockchain system for blockchain transactions for users, the system comprising:
a plurality of nodes, wherein the plurality of nodes communicates over a network assembly;
a network interface assembly comprising one or more network devices;
at least one control circuit assembly adapted to receive and transmit information via the network assembly;
a game environment with at least one or more of virtual game space, game time, virtual game objects, and game avatars is disposed within the at least one computer-readable storage memory assembly wherein users execute moves, the moves allowing users to earn from outcomes of moves at least one or more of tokens, skills, and tools, the tools being an element of the virtual game objects and the skills being an element of the game avatars;
a layer-one blockchain network;
a validator adapted to validate moves and move outcomes;
a transaction aggregator adapted to accumulate related transactions in the layer-one blockchain;
at least one computer-readable storage memory assembly, wherein the computer-readable storage memory assembly comprises a volatile memory storing a set of one or more computer-readable interactions, which when executed by the control circuit assembly cause the plurality of nodes to update the blockchain stored in a memory assembly based on communication with other nodes over the network assembly, the blockchain adapted to be updated with at least one or more of the outcomes and increments of the outcomes; and
the accumulated related transactions viewable on one or more user interfaces wherein at least one or more of moves, outcomes of moves, associated non-interchangeable units of data, the tokens, the tools, the virtual game space, the game time, the virtual game objects, and the game avatars are viewable from the accumulated related transactions within the game environment by way of at least one or more encrypted private keys.

2. The distributed blockchain system of claim 1, the system further including secured retrievable digital content disposed on the at least one control circuit assembly, the retrievable digital content including at least one evolving avatar wherein the avatar is evolvable into at least one or more of appearance and capabilities at least one or more of automatically and on demand upon reaching a threshold, the threshold including one or more from a group of spatial considerations, temporal considerations, material considerations, and considerations associated with handling risks.

3. The distributed blockchain system of claim 1, wherein avatars are created as one or more sets of avatars (A1, A2, A3 . . . An) that are controlled inside of the game wherein the user can access one avatar of the set of avatars at a time, the avatar evolvable wherein an evolved avatar represents an older version of a corresponding and previous avatar of the given set of avatars (A1, A2, A3 . . . An).

4. The distributed blockchain system of claim 1, wherein the mining enterprise mines at least one block, a plurality of transactions held in each block therein up to between 2.8 gigabytes and 5.0 gigabytes, the ancestry pool set to 8,000 to 15,000 transactions per block related to each other.

5. The distributed blockchain system of claim 1, the system further including explicit transactions wherein users execute moves in the game environment, the moves allowing users to earn from outcomes of moves at least one or more of tokens, skills, and tools, the explicit transactions recorded on the plurality of nodes.

6. The distributed blockchain system of claim 5, wherein the explicit transaction means is Bitcoin SV.

7. The distributed blockchain system of claim 1, wherein users dispense at least one token portion to perform actions within the game environment and may receive at least one token portion as a prize or reward.

8. A distributed blockchain method for blockchain transactions for users in a game environment, the method comprising the steps of:
receiving a first plurality of data from one or more computer assemblies from a game environment with at least one or more of virtual game space, game time, virtual game objects, and game avatars disposed within the at least one computer-readable storage memory assembly wherein users execute moves, the moves allowing users to earn from outcomes of moves at least one or more of tokens, skills, and tools, the tools being an element of the virtual game objects and the skills being an element of the game avatars;
generating from the move transactions in a layer-one blockchain network;
providing a validator validating moves and move outcomes, the validator ensuring transaction events in real time, and preventing double-spending, the moves and outcomes of moves viable as transaction events;
providing a transaction aggregator accumulating from an ancestry pool of related transactions in the layer-one blockchain;
providing at least one computer-readable storage memory assembly executing operations by the control circuit assembly, wherein the computer-readable storage memory assembly comprises a volatile memory storing a set of one or more computer-readable interactions, causing the plurality of nodes to update the blockchain stored in a memory assembly based on communication with other nodes over the network assembly, the blockchain updated with at least one or more of the outcomes and increments of the outcomes;
the updated blockchain including creating at least one non-interchangeable unit of data stored on the blockchain, forming a digital ledger;
sending transactions to at least one mining enterprises at least one or more of directly, in bulk, in parallel, in sequence order, and at random, the mining enterprise mining at least one block, a plurality of transactions held therein; and
viewing on demand the accumulated related transactions viewable on one or more user interfaces wherein at least one or more of moves, outcomes of moves, associated non-interchangeable units of data, the tokens, the virtual game space, the game time, the virtual game objects, and the game avatars are viewable from the accumulated related transactions within the game environment by way of at least one or more encrypted private keys.

9. The distributed blockchain method for blockchain transactions for users in a game environment of claim 8, the method further including evolving avatars wherein the avatars evolve in at least one or more of appearance and capabilities at least one or more of automatically and on demand upon reaching a threshold, the threshold including one or more from a group of spatial considerations, temporal considerations, material considerations, and considerations associated with handling risks.

10. The distributed blockchain method for blockchain transactions for users in a game environment of claim 8, the method further involving creating avatars as sets of avatars (A1, A2, A3 . . . An) and controlling the avatars inside the game, the user accessing one avatar of the set of avatars at a time, the avatars evolving, the evolved avatars representing older versions of corresponding and previous avatars of the given set off avatars (A1, A2, A3 . . . An).

11. The distributed blockchain method for blockchain transactions for users in a game environment of claim 8, the method further involving, performing explicit transactions wherein users execute moves in the game environment, the moves allowing users to earn from outcomes of moves at least one or more of tokens, skills, and tools, the tools being an element of the virtual game objects and the skills being an element of the game avatars, and recording the explicit transactions on the plurality of nodes, explicit transactions further distributed as NFTs in the marketplace.

12. The distributed blockchain method for blockchain transactions for users in a game environment of claim 11, the method further including using Bitcoin SV as a base layer.

13. The distributed blockchain method for blockchain transactions for users in a game environment of claim 8, the method further involving dispensing at least one token portion to perform action within the game environment and receiving at least one token portion as a prize or reward.

14. A distributed blockchain system for blockchain transactions for users, the system comprising:
a plurality of nodes, wherein the plurality of nodes communicates over a network assembly;
a network interface assembly comprising one or more network devices;
at least one control circuit assembly adapted to receive and transmit information via the network assembly;
a transaction environment with at least one or more of virtual space, time, virtual objects, and avatars is disposed within the at least one computer-readable storage memory assembly wherein users execute actions, the actions allowing users to earn from outcomes of actions at least one or more of tokens, skills, and tools, the tools being an element of the virtual game objects and the skills being an element of the game avatars;
a layer-one blockchain network;
a validator adapted to validate moves and move outcomes;
a transaction aggregator adapted to accumulate related transactions in the layer-one blockchain;
at least one computer-readable storage memory assembly, wherein the computer-readable storage memory assembly comprises a volatile memory storing a set of one or more computer-readable interactions, which when executed by the control circuit assembly cause the plurality of nodes to update the blockchain stored in a memory assembly based on communication with other nodes over the network assembly, the blockchain adapted to be updated with at least one or more of the outcomes and increments of the outcomes; and
the accumulated related transactions viewable on one or more user interfaces wherein at least one or more of moves, outcomes of moves, associated non-interchangeable units of data, the tokens, the tools, the virtual space, the time, the objects, and the avatars are viewable from the accumulated related transactions within the transaction environment by way of at least one or more encrypted private keys.

15. The distributed blockchain system of claim 14, the system further including secured digital content disposed on the at least one control circuit assembly, the retrievable digital content including at least one evolving avatar wherein the avatar is evolvable into at least one or more of appearance and capabilities at least one or more of automatically and on demand upon reaching a threshold, the threshold including one or more from a group of spatial considerations, temporal considerations, material considerations, and considerations associated with handling risks.

16. The distributed blockchain system of claim 15, wherein avatars are created as one or more sets of avatars (A1, A2, A3 . . . An) that are controlled inside of the transaction environment wherein the user can access one avatar of the set of avatars at a time, the avatar evolvable wherein an evolved avatar represents an older version of a corresponding and previous avatar of the given set off avatars (A1, A2, A3 . . . An).

17. The distributed blockchain system of claim 15, wherein the user dispenses at least one token portion to perform action within the transaction environment and may receive at least one token portion as a prize or reward.

18. The distributed blockchain system of claim 15, wherein the mining enterprise mines at least one block, a plurality of transactions held in each block therein up to between 2.8 gigabytes and 5.0 gigabytes, the ancestry pool set to 8,000 to 15,000 transactions per block related to each other.

19. The distributed blockchain system of claim 15, the system further including explicit transactions wherein users execute moves in the transaction environment, the moves allowing users to earn from outcomes of moves at least one or more of tokens, skills, and tools, the tools being an element of the virtual game objects and the skills being an element of the game avatars, the explicit transactions recorded on the plurality of nodes.

20. The distributed blockchain system of claim 19, wherein the explicit transaction means is Bitcoin SV.
